(19) United States
(12) Patent Application Publication
(10) Pub. No.: US 2006/0201416 A1
(43) Pub. Date: Sep. 14, 2006

(54) Superb batter

(76) Inventor: Veronica Davis, Gordo, AL (US)

Correspondence Address: Veronica Davis, P.O. Box 511, Gordo, AL, 35466, US

(21) Appl. No.: 10/950,213

(22) Filed: Mar. 14, 2005

(51) Int. Cl. A23G 3/26

(52) U.S. Cl. 118/19; 118/13

(57) ABSTRACT

The Superb Batter consists of double bowls that will let you put your meat in the batter. Push the power button, the bowls will begin rotation. In about 20 seconds, your chicken, fish, etc. will be coated evenly. You can, then, put your meat into the deep fryer or frying pan and begin cooking it. However, I came up with this idea of how nice it would be to use or have a batter that you didn't have to continue to put your hands in all day long. I own and manage a fast food business, and I am constantly battering fish and chicken with my hands. I think the Superb Batter is a great idea to introduce to restaurants, owners, and homemakers.

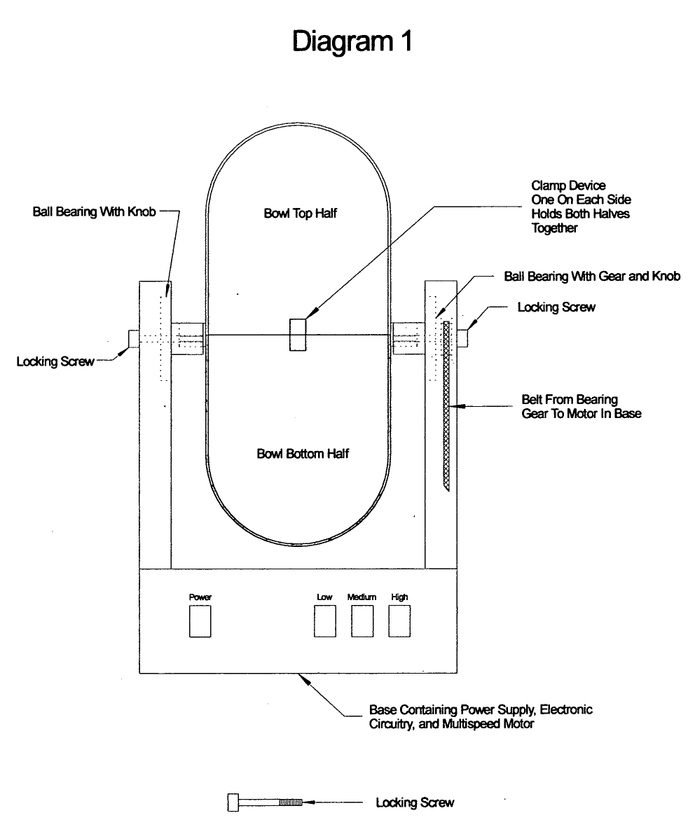

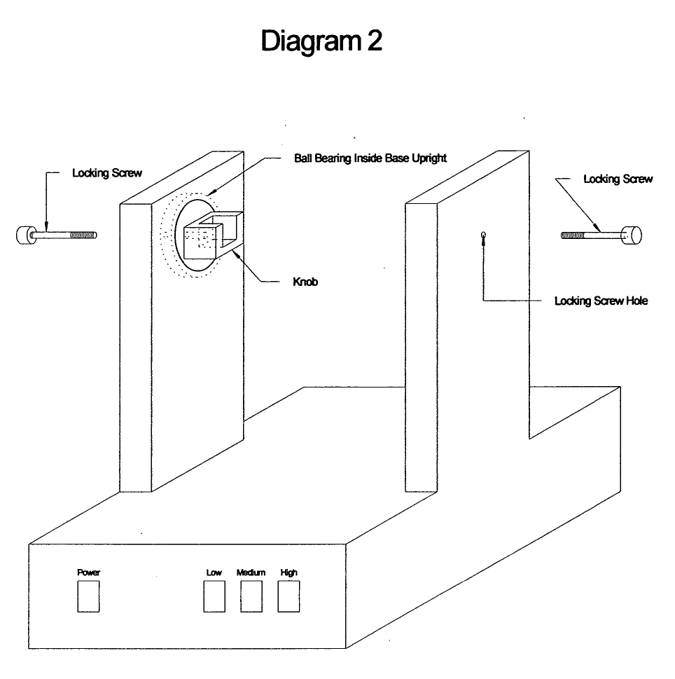

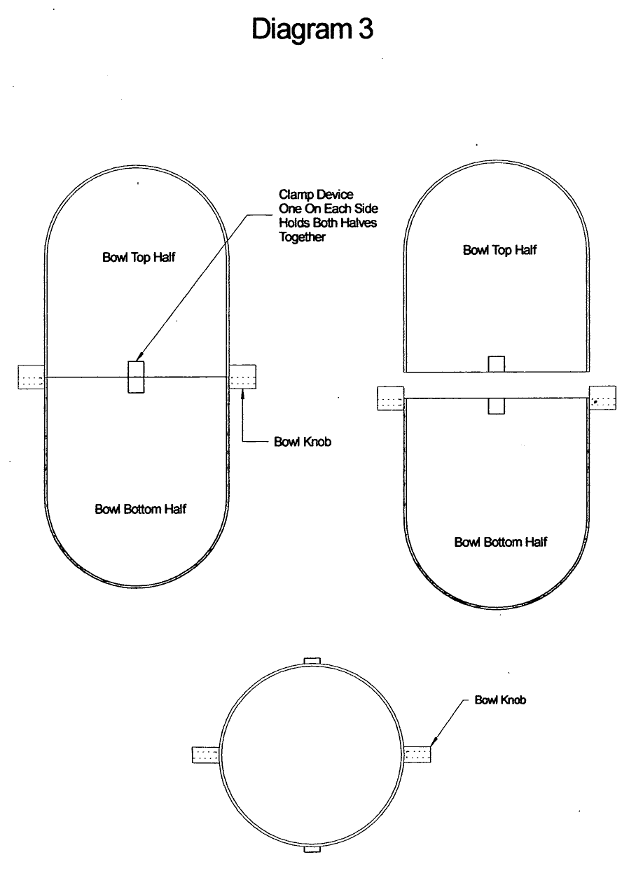

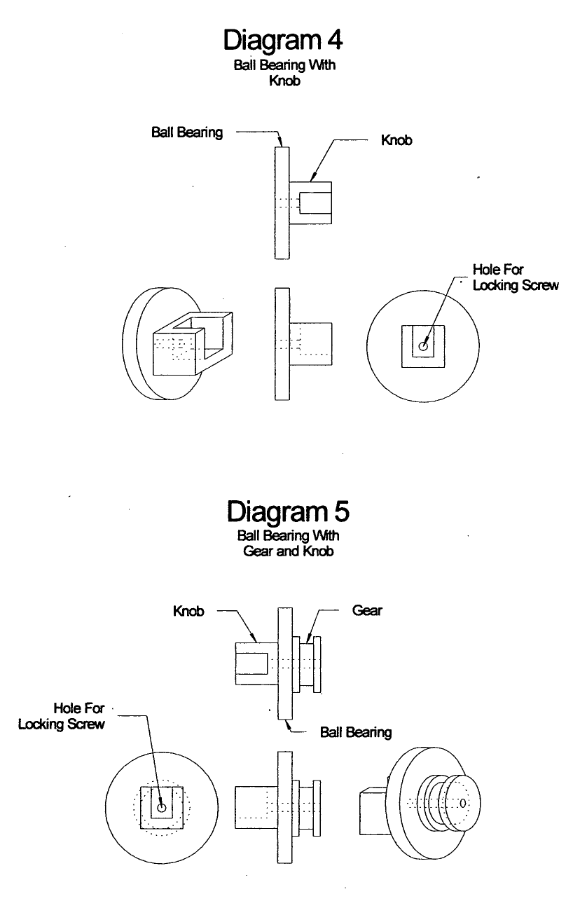

The SurPerb Batter consists of two bowls. The bowls will be made out of a very durable plastic. Each bowl will measure three (3) quarts in size. It will have a right screw and a left screw. The screws will completely lock in place of the base of the Batter. The Batter will also contain a left and right ball bearing with gears and knobs. These ball bearing gears will help the batter rotate without coming apart. The clamping device is located in the back and in the front of the Batter.

This device clamps down tight holding both bowls together while the Batter is in a rotating motion. The belt from the bearing gear that is located in the side of the right and left base of the Batter will run to the motor which is located in the bottom of the base. These belts rotate the bowls around when the power is on. This also helps evenly coat the meats that are in the bowls. The power button is located at the bottom of the base where there are also multi-speed controls. The speeds are supplied by the motor which sits in the bottom of the base of the Batter. The multi-speeds are controlled by the power button. This turns the Batter on and you may make your selection of low, medium, or high power.

1. I, Veronica Davis, claim the SurPerb Batter. It has a top bowl and a bottom bowl. It also has a right and left ball bearing gear that runs to the motor in the bottom base part of the Batter. It has a clamping device in front and in the back of the Batter. This device holds the Batter together. While it is in rotating motion, the bottom part of the base has multi-speeds. There is power button which consists of low, medium, and high. The base part of the Batter supplies the electronic circuit and, of course, the multi-speed motor.
